(19) United States
(12) Patent Application Publication
(10) Pub. No.: US 2010/0003965 A1
(43) Pub. Date: Jan. 7, 2010

(54) METHOD FOR DETERMINING A RANGE OF CLOSED SUBSCRIBER GROUP IDENTITIES FOR OPEN NETWORK ACCESS

(76) Inventors: Michael Kurz, Wien (AT); Michele Zarri, London (GB)

Correspondence Address: Law Offices of Robert F. Zielinski, LLC, 1518 Walnut Street, Suite 1706, Philadelphia, PA, 19102, US

(21) Appl. No.: 12/497,716

(22) Filed: Jul. 6, 2009

(30) Foreign Application Priority Data
Jul. 3, 2008 (DE) 10 2008 031 211.8

(51) Int. Cl. H04M 1/66

(52) U.S. Cl. 455/411

(57) ABSTRACT

Method for operating one or more radio cells of a cellular mobile wireless network, and cellular mobile wireless system, wherein each radio cell may be identified by a broadcasted cell identifier, and wherein use may be limited to a closed subscriber group by the fact that the radio cell has a corresponding identifier, and mobile wireless terminals log into the particular radio cell to use the services of the mobile wireless network only after a match has been made with a positive list of allowed cell identifiers stored in the mobile wireless terminal. The cell identifier is variable, and on the basis of the cell identifier a determination may be made as to whether log-in and use of the network services is limited to the closed subscriber group at that moment, or alternatively, whether log-in and use of the network services is enabled for any subscriber.

The invention relates to a method for operating one or more radio cells of a cellular mobile wireless network, wherein each radio cell may be identified by a broadcasted cell identifier, and wherein use may be limited to a closed subscriber group by the fact that the radio cell has a corresponding identifier, and mobile wireless terminals log into the particular radio cell to use the services of the mobile wireless network only after a match has been made with a positive list of allowed cell identifiers stored in the mobile wireless terminal.

The invention further relates to a cellular mobile wireless system having a mobile wireless network with a plurality of radio cells which mobile wireless terminals may log into in order to use the services of the mobile wireless system, wherein each radio cell may be identified by a broadcasted cell identifier, and wherein use may be limited to a closed subscriber group by the fact that the radio cell has a corresponding identifier, and mobile wireless terminals log into the particular radio cell to use the services of the mobile wireless network only after a match has been made with a positive list of allowed cell identifiers stored in the mobile wireless terminal.

It is known to limit one or more radio cells of a mobile wireless network exclusively to a closed subscriber group (CSG). Using mobile wireless technology, a mobile wireless operator may specify one cell or a group of cells as part of a closed subscriber group (CSG). These cells are specified by a corresponding identifier (closed subscriber group identity—CSG ID). A mobile terminal, i.e., a mobile wireless terminal (user equipment (UE), mobile telephone, or the like) attempts to access a cell associated with the closed subscriber group CSG only when the corresponding cell identifier (CSG ID) is contained in a list (“white list”) of allowed subscriber groups or radio cells. A white list or positive list, in comparison to a black list, refers, among other things, to persons, companies, and elements which in the opinion of the creator of the list are defined as trustworthy. This/these list(s) is/are maintained and administered by the mobile wireless operator to which the mobile wireless terminal is subscribed in the corresponding mobile wireless network (home public land mobile network—HPLMN).

It is disadvantageous that in cells which are subject to the closed subscriber group, normally there is no network access for users of other networks or companies without involving the home network.

The object of the invention is to refine a method for operating one or more radio cells of a cellular mobile wireless network, and a corresponding cellular mobile wireless system having a range of closed subscriber group identities, in such a way that open network access is possible.

This object is achieved according to the invention by use of the method and the cellular mobile wireless system stated in the independent claims. Advantageous refinements of the invention are stated in the dependent claims.

In the method for operating one or more radio cells of a cellular mobile wireless network, wherein each radio cell may be identified by a broadcasted cell identifier, and wherein use may be limited to a closed subscriber group by the fact that the radio cell has a corresponding identifier, and mobile wireless terminals log into the particular radio cell in order to use the services of the mobile wireless network only after a match has been made with a positive list of allowed cell identifiers stored in the mobile wireless terminal, it is particularly advantageous that the cell identifier is variable, and on the basis of the cell identifier a determination may be made as to whether log-in and use of the network services is limited to the closed subscriber group at that moment, or alternatively, whether log-in and use of the network services is enabled for any subscriber.

For the cellular mobile wireless system, in particular for carrying out and using the method according to the invention, having a mobile wireless network with a plurality of radio cells in which mobile wireless terminals may log into in order to use the services of the mobile wireless system, wherein each radio cell may be identified by a broadcasted cell identifier, and wherein use may be limited to a closed subscriber group by the fact that the radio cell has a corresponding identifier, and mobile wireless terminals log into the particular radio cell in order to use the services of the mobile wireless network only after a match has been made with a positive list of allowed cell identifiers stored in the mobile wireless terminal, it is particularly advantageous that the cell identifier is variable, and on the basis of the cell identifier a determination may be made as to whether log-in and use of the network services is limited to the closed subscriber group at that moment, or alternatively, whether log-in and use of the network services is enabled for any subscriber.

As a result of the cell identifier for one or more radio cells of a cellular mobile wireless network being variable, use of the particular radio cell may be temporarily or permanently limited to a closed subscriber group as a closed subscriber group identity (CSG ID), or alternatively, enabled for open network access. The particular cell identifier may be administered on the network side. Thus, the difference and particular advantage compared to the known operating methods and known cellular mobile wireless systems is that the cell identifier for one or more radio cells of the cellular mobile wireless system has a variable design, and this variability represents a criterion for limiting network access or open network access.

The terms “mobile wireless terminal” or “mobile terminal,” in particular user equipment (UE) or mobile telephone, are also intended to mean the subscriber-specific subscriber identification modules associated with the mobile wireless terminal, i.e., the carriers of the subscriber's identity (international mobile subscriber identity—IMSI), and therefore also refer, for example, to chip cards or other types of subscriber identity modules (SIM/USIM), as well as software solutions such as a virtual subscriber identity module (virtual SIM/USIM), for example.

The cell identifier may preferably be varied by varying one bit, multiple bits, or a series of bits of the cell identifier, and in particular the cell identifier has a length of 28 bits.

As the result of a bit or a given series of bits of a cell identifier, i.e., a CSG ID, indicating whether access to cells associated with the closed subscriber group is possible by use of a mobile terminal, even when this cell identifier is not entered in the white list of the mobile terminal, it is advantageously possible to easily enable or block a range of a closed subscriber group for open network access.

In the method and/or system, a comparison with the positive list of allowed cell identifiers stored in the mobile wireless terminal is preferably omitted when a given bit, multiple given bits, or a given series of bits of the cell identifier have a specified value. When the cell identifier, i.e., the CSG ID, indicates that the cell is available for open network access, a comparison with the positive list (white list) stored in the mobile wireless terminal may be omitted, and the network services may be used by the fact that the mobile wireless terminal logs in directly to the mobile wireless network.

The mobile wireless terminal may preferably be uniquely identified by means of a subscriber identity (international mobile subscriber identity—IMSI) and authenticated with respect to the radio cell upon log-in; i.e., authentication of the mobile wireless terminal or the subscriber associated with the mobile wireless terminal also takes place directly upon log-in to the mobile wireless network.

Thus, by use of the method according to the invention and the mobile wireless system according to the invention a range of closed subscriber group identities (CSG ID) may be determined, and in general or on a temporary basis may be enabled for open network access.

One exemplary embodiment of the invention is illustrated in the figures and explained in greater detail below. The figures show the following:

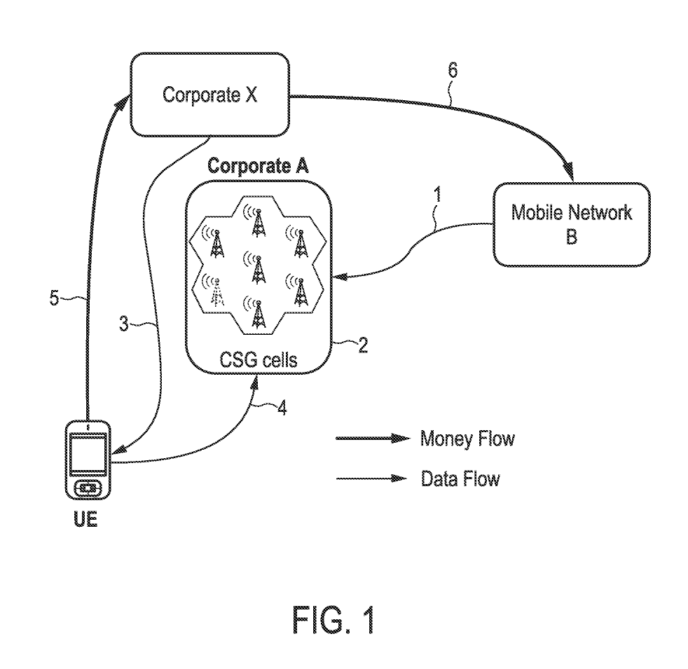

FIG. 1 shows a diagram of the integration of a group of cells of a closed subscriber group into a mobile wireless network, and the use of this range of radio cells by a mobile wireless terminal;

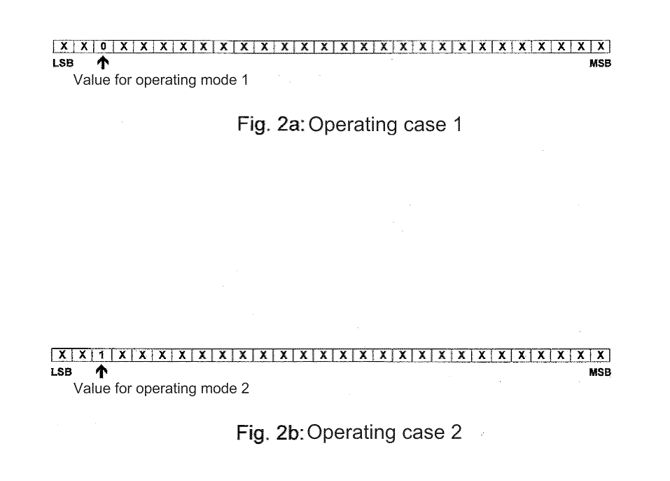

FIG. 2a shows an example of a 28-bit cell identifier in a first operating mode; and

FIG. 2b shows the 28-bit cell identifier according to FIG. 2a in a second operating mode.

In the case schematically illustrated in FIG. 1, a company “Corporate A,” for example, operates several radio cells 2 which are operated by a mobile network operator B and made available.

The company “Corporate A” accordingly operates the cells 2 in order to roll out or operate a public, or alternatively, an in-house, CSG network for a closed subscriber group. According to the schematic illustration in FIG. 1 the operation is carried out as follows:

1. Mobile network operator B makes available a corresponding cell identifier (CSG ID) and indicates that public access is possible (1).

2. The frequencies at which the CSG cells of the company “Corporate A” are operated belong to mobile network operator B, which makes the cells 2 available.

3. A mobile wireless terminal, i.e., mobile terminal UE (user equipment), authenticates an outside company X “Corporate X,” i.e., a company which does not belong to the closed subscriber group of operator A of the radio cells 2, i.e., company “Corporate A.”

4. The user of the mobile terminal UE is able to use the CSG cells 2 when these cells are operated in the appropriate mode for open network access.

5. In order to use the cells 2 operated by company “Corporate A,” the user of the mobile wireless terminal UE pays company X “Corporate X,” with which the mobile wireless terminal UE used is associated as a user, the appropriate usage fees.

6. The company “Corporate X,” which has provided the mobile wireless terminal UE used in the cells 2 and has authenticated the mobile wireless terminal, pays to operator B (mobile network operator B), which provides the frequencies for the corresponding CSG cells being used and operated, appropriate usage fees for use of the CSG cells 2 which are operated by the third party (Corporate A) in the network of mobile network operator B.

Thus, FIG. 1 illustrates the operating scheme as well as the data flow 1, 3, and 4 and the payment flow 5, 6 for use of the CSG cells 2 within the mobile wireless network of mobile network operator B.

FIG. 2 illustrates two examples of an address range, having a length of 28 bits, of a cell identifier, i.e., a CSG ID, from the least significant bit (LSB) on the left side to the most significant bit (MSB) on the right side.

FIGS. 2a and 2b illustrate two different operating cases, which are explained below.

The CSG ID address range having a length of 28 bits is divided into two regions, for example XX0XX . . . X for using the positive list or white list which is stored in a mobile wireless terminal, and XX1XX . . . X for indicating open network access. The letter X denotes a state of the bits which is not defined in greater detail. The position of the bit, which could also be a series of bits, as well as the evaluation state 0 or 1 are selected purely at random in this case.

In the first operating case or operating mode according to FIG. 2a, the cell identifier (CSG ID) begins with “XX0.” The mobile wireless terminal (UE) will attempt to access cells having such a cell identifier (CSG ID), beginning with broadcasted “0”, only when the full cell identifier (CSG ID) is present in the positive list or white list of allowed cell identifiers. In other words, in this first operating case, before the mobile wireless terminal logs into this radio cell a comparison is made with the white list stored in the mobile wireless terminal.

In the operating case or operating mode illustrated in FIG. 2b, the cell identifier (CSG ID) begins with “XX1.” The mobile terminal is allowed to attempt to access cells having a corresponding cell identifier (CSG ID), beginning with broadcasted “1”; i.e., this cell is available for open network access.

Thus, in the illustrated example the third bit of the total 28-bit cell identifier CSG ID is used to indicate whether the particular radio cell in a first operating mode (identifier “XX0”) is available only for a closed subscriber group, or in the second operating case having cell identifier “XX1,” indicates open access and also allows mobile wireless terminals which do not belong to the closed subscriber group to log into the mobile wireless network.

The advantage of the approach according to the invention is that it allows users of other companies or other subscriber groups to access a CSG cell without involving the home public land mobile network HPLMN, and independently of the business model between the HPLMN for the mobile terminals and the public land mobile network (PLMN), which provide the frequencies and wireless technology for network coverage.

An identification, i.e., a distinction as to whether use of the network services is possible, may therefore be made very easily and also reliably by use of the broadcasted cell identifier CSG ID to indicate whether the particular radio cell is limited to a closed subscriber group or is available for open network access.

1. A method for operating at least one radio cell of a cellular mobile wireless network, wherein said at least one cell comprises a broadcasted cell identifier, and wherein access to said network is limited to a closed subscriber group by a corresponding identifier, and further wherein at least one mobile wireless terminal logs into said at least one radio cell within said network only after a match with a list of allowed cell identifiers stored in said at least one mobile wireless terminal has been made, wherein further said cell identifier is variable, and on the basis of said cell identifier a determination is made as to whether access to said network is limited to said closed subscriber group, or, whether access to said network is enabled for other than said closed subscriber group.

2. The method according to claim 1, characterized in that the cell identifier has a length of 28 bits and may be varied by varying any one of one bit, multiple bits, and a series of bits.

3. The method according to claim 1, wherein a comparison with said list of allowed cell identifiers stored in said at least one mobile wireless terminal is omitted when a given bit, multiple given bits, and a given series of bits of the cell identifier have a specified value.

4. The method according to claim 1, wherein said at least one mobile wireless terminal is uniquely identified by means of a subscriber identity and is authenticated with respect to said cell upon log-in.

5. A cellular mobile wireless system having a mobile wireless network with a plurality of radio cells in which mobile wireless terminals log into in order to access said mobile wireless system, wherein at least one radio cell is identified by a broadcasted cell identifier, and wherein access is limited to a closed subscriber group by a corresponding identifier, and wherein at least one mobile wireless terminal logs into said at least one radio cell in order to access said mobile wireless network only after a match has been made with a list of allowed cell identifiers stored in said at least one mobile wireless terminal, wherein said cell identifier is variable, and on the basis of said cell identifier a determination is made as to whether access to said network is limited to said closed subscriber group, or, whether access to said network is enabled for other than said closed subscriber group.

6. The system according to claim 5, characterized in that the cell identifier has a length of 28 bits and may be varied by varying any one of one bit, multiple bits, and a series of bits.

7. The system according to claim 5, wherein a comparison with said list of allowed cell identifiers stored in said at least one mobile wireless terminal is omitted when a given bit, multiple given bits, and a given series of bits of the cell identifier have a specified value.

8. The system according to one of claims 5, wherein said at least one mobile wireless terminal is uniquely identified by means of a subscriber identity and is authenticated with respect to said cell upon log-in.
